(19) United States
(12) Patent Application Publication
(10) Pub. No.: US 2016/0172942 A1
(43) Pub. Date: Jun. 16, 2016

(54) ACTUATOR SYSTEM

(71) Applicant: LINAK A/S, Nordborg (DK)

(72) Inventor: Jeppe Christian BASTHOLM, Sonderborg (DK)

(21) Appl. No.: 14/902,642

(22) PCT Filed: Jul. 4, 2014
(86) PCT No.: PCT/DK2014/000037

§ 371 Date: Jan. 4, 2016

(30) Foreign Application Priority Data
Jul. 4, 2013 (DK) PA 2013 00408

(51) Int. Cl. H02K 11/02

(52) U.S. Cl. CPC H02K 11/02

(57) ABSTRACT

Actuator system comprising at least one electrically driven linear actuator with an electric motor and an electric controller with an operating unit, wherein the electric motor is furnished with means for electrical noise dampening of the motor, which comprises a first inductance and a second inductance for electrical noise dampening of the motor, said first and second inductance are physically wound on the same coil form and thus provides a more compact construction, which moreover reduces the costs.

The invention relates to an actuator system comprising at least one housing, at least one electrically driven linear actuator with an electric motor, a transmission, a spindle connected to the electric motor via the transmission, on said spindle a spindle nut is mounted, and an electric controller with an operating unit, a first circuit for a first electrical noise dampening of the electric motor comprising a first inductance and at least one capacitor, a second circuit for a second electrical noise dampening of the motor, arranged between the first circuit for the first electrical noise dampening of the electric motor and the electric controller comprising a second inductance.

Actuator systems with linear electrically driven actuators are widely used within the field of adjustable furniture, such as e.g. adjustable tables, adjustable beds and chairs. Linear electrically driven actuators are moreover used in countless other industrial products, in which a linear electrically driven actuator for adjusting a mechanical moveable component is expediently integrated in a mechanical structure.

For a manufacturer it is possible to purchase a complete actuator system with linear electrically driven actuators and a controller for simple integration into the product concerned. This provides the advantage that the manufacturer can focus on the product without regard for actuator specific problems, which have already been taken into consideration by the manufacturer of the actuator. Here, particularly reduction of electrical and magnetic noise, which is subject to regulatory legal requirements, is considered. Generation of noise mainly relates to the use of DC motors, where the brushes of the commutator in the electrical connection with the coils of the armature, during operation of the motor, continuously switches the power supply to the coils of the armature for creating a torque. The inductive effect of the coils during the commutation will generate electrical noise, which will propagate back towards the controller.

There is, however, a tendency in the marked towards the manufacturer wishing to buy the linear electrically driven actuator separately and creating an extension to his own controller in preparation for controlling and driving the linear electric actuator directly therefrom. This provides obvious financial advantages and a simpler construction.

However, new challenges arise in connection with the mandatory noise dampening. This challenge is present even though the manufacturer of the actuator builds noise dampening means into the actuator. This is owing to the fact that the circuit for noise dampening of the electrically driven actuator will have to be designed differently depending on how the customer wishes to control the actuator.

The most common type of noise dampening of a DC motor is by insertion of inductance connected in series between the commutator and the terminals of the DC motor, which effectively prevents the noise from propagating back towards the controller. Capacitors are located in parallel over the terminals for connection with the controller, said capacitors effectively absorbing the energy of the high-frequency noise generated by the commutation. These capacitors are connected to the motor housing through one of the terminals.

This manner of noise dampening of a DC motor is for that matter fine if the DC motor is driven directly from a regulated DC supply, such as e.g. a battery or a power supply, by direct operation of a switch, which connects and interrupts the supply to the DC motor.

In case it is desired to control the motor by pulse width modulation of the operating voltage, e.g. by means of a switch-mode controller, with the appertaining advantages with regard to energy efficiency and speed control, the noise dampening will complicate the controlling of the DC motor. The presence of the capacitor will result in that a large current for charging as well as discharging of the capacitor will run during the switching. Transistors are normally used as switches, typically of the FET type, which when fully equipped or open, have a low ON-resistance. When the switch is closed, the ON-resistance is high. The speed of the shift between the on and off state is however crucial to the switch loss i.e. how much power is dissipated in the transistor, when the transistor is switched on or off—the higher the current the larger the switch loss. If the frequency of the pulse-width modulation is increased the switch loss is needless to say increased correspondingly. In other words, the noise dampening capacitor will cause a large energy loss during switching, which counteracts the advantages, which the customer wishes to achieve by using pulse-width modulation of the operating voltage of the motor. Likewise, demands are made on the transistor in the switch-mode controller, for it to be able to handle the high peak current without being damaged.

This can be overcome by inserting an inductance in the output stage of the switch-mode controller, which dampens the switch current. Insertion of such an inductance is however price-raising for the construction. Moreover, the manufacturer will have to handle the building-in himself. Alternatively, the manufacturer of the actuator can provide different configurations of the actuator, where the customer actively must choose the configuration, which fits the desired manner of controlling.

It is thus challenging in terms of logistics, with significant costs involved for both the actuator manufacturer as well as the customer, to ensure that the actuator is equipped with means for noise dampening, which fit the manner in which the customer wishes to supply and control the DC motor of the actuator. There is a possible risk of the customer choosing an actuator with an inadequate or inappropriate noise dampening resulting in the appertaining disadvantages in terms of error correction etc.

The purpose of the invention is to provide a solution to the outlined problem, i.e. to provide a circuit for noise dampening of a DC motor in a linear electric actuator, which may be used both for DC operation as well as for pulse-width modulated operation of the motor. A solution is further desired, which is more compact and not vastly price-raising, if possible a more inexpensive or a price-neutral solution.

This is achieved according to the invention by designing the actuator system as stated in claim 1, comprising a coil, where the first inductance and the second inductance constitute a first section and a second section of the coil, respectively.

More specifically, the actuator system comprises at least one housing, at least one electrically driven linear actuator with an electric motor, a transmission, a spindle connected to the electric motor via the transmission, on said spindle a spindle nut is mounted, and an electric controller with an operating unit, a first circuit for a first electrical noise dampening of the electric motor comprising a first inductance and two capacitors, a second circuit for a second electrical noise dampening, arranged between the first circuit for a first electrical noise dampening of the electric motor and the electric controller, comprising a second inductance and a capacitor, wherein the first inductance and the second inductance constitute a first section and a second section of the coil, respectively.

The arrangement according to the invention thus moves a component located outside the electric motor and the actuator (normally arranged in the controller) and assembles this with a component located with the electric motor in the motor housing, thus creating a compact solution, which moreover is more cost-efficient, as the price of the combined component is only slightly higher than the component originally located in the motor housing. The combination is not self-evident as the two components, which are integrated, regardless of being the same nature, are inserted with different purposes and contribute to a very different technical effect in the construction.

Depending on the wire thickness and the choice of material for the winding of the coil, the winding can constitute a self-supporting mechanical construction and thus does not require support. However expediently, the housing of the electric motor is furnished with means for retaining the coil during mounting and operation, such that the electric conductors are arranged isolated in a manner to avoid short-circuiting.

If the conductors of the winding are made from a material or are of such a dimension that the coil does not constitute a self-supporting mechanical construction, the winding can be wound on one and the same coil form.

In that the coil for the first and the second noise dampening is wound on the same coil form a more compact design is achieved, as it to a greater extent is the coil form rather than the windings on it, which take up space. Thus, the costs of a coil form are also saved.

The winding machine can wind the two sections of the coil in one cycle, which further saves costs. In this embodiment both windings can be independent without electrical connection between the two windings.

Further costs can be saved by winding the first section and the second section of the coils as one interconnected winding with a tap, said tap being a common midpoint, which divides the coils into two sections.

The coil can as a unit or individually, on each of the two sections, be furnished with a core consisting of a material containing ferrite. Thus, the inductance of the coil is improved, for which reason a physically smaller coil will be sufficient for the necessary noise dampening with the appertaining advantages in the form of a more compact design and cost savings.

As the solution is compact the coil and the additional components in the first and second circuit for electrical noise dampening of the motor are expediently arranged in the housing of the motor or mounted on the terminals of the motor.

In another embodiment the coil and the additional components in the first and second circuit for electric noise dampening of the motor are arranged in the controller. The electrical noise from a non-silenced motor in an electric actuator will in this embodiment nevertheless be sufficiently dampened.

In a further embodiment the coil and the additional components in the first and second circuit for electrical noise dampening of the motor are arranged in the housing of the actuator. The electric actuator can be equipped with a printed circuit board, on which discrete electrical components are mounted. This printed circuit board can be fitted with the components for the electrical noise dampening of the motor. In yet another embodiment the components are arranged in the cable connection, connected to the electric motor, or are mounted directly in the socket for the plug connection to the motor.

In an embodiment the coil and the additional components in the first and second circuit for electrical noise dampening are arranged in a separate housing. The housing can be furnished with appropriate plug connections such that this can be inserted between the motor in the electric actuator and the controller. The housing can also be equipped with a through-going cable connection, which with appropriate plug connections can be inserted between the motor in the electric actuator and the controller.

A linear electric actuator system according to the invention will be described more fully below with reference to the accompanying drawing, in which:

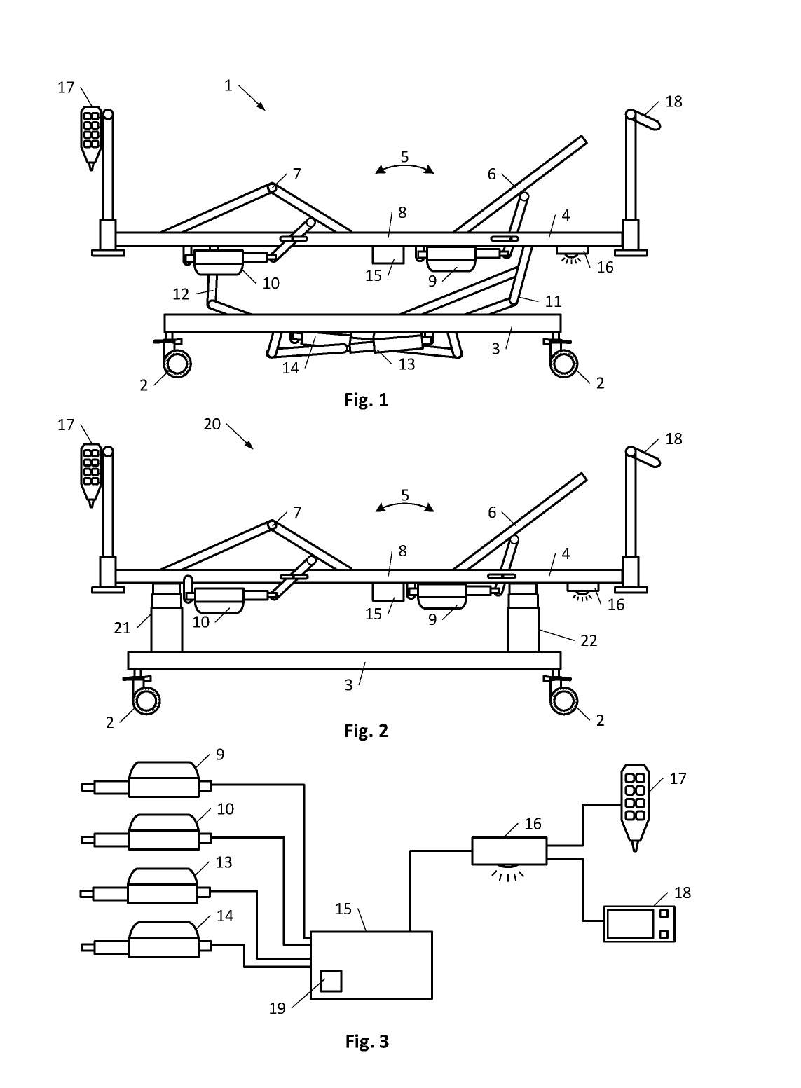

FIG. 1 shows a schematic view of a hospital or care bed comprising an actuator system in a first embodiment,

FIG. 2 shows a schematic view of a hospital or care bed comprising an actuator system in another embodiment,

FIG. 3 shows a block diagram of the actuator system on the beds shown in FIG. 1,

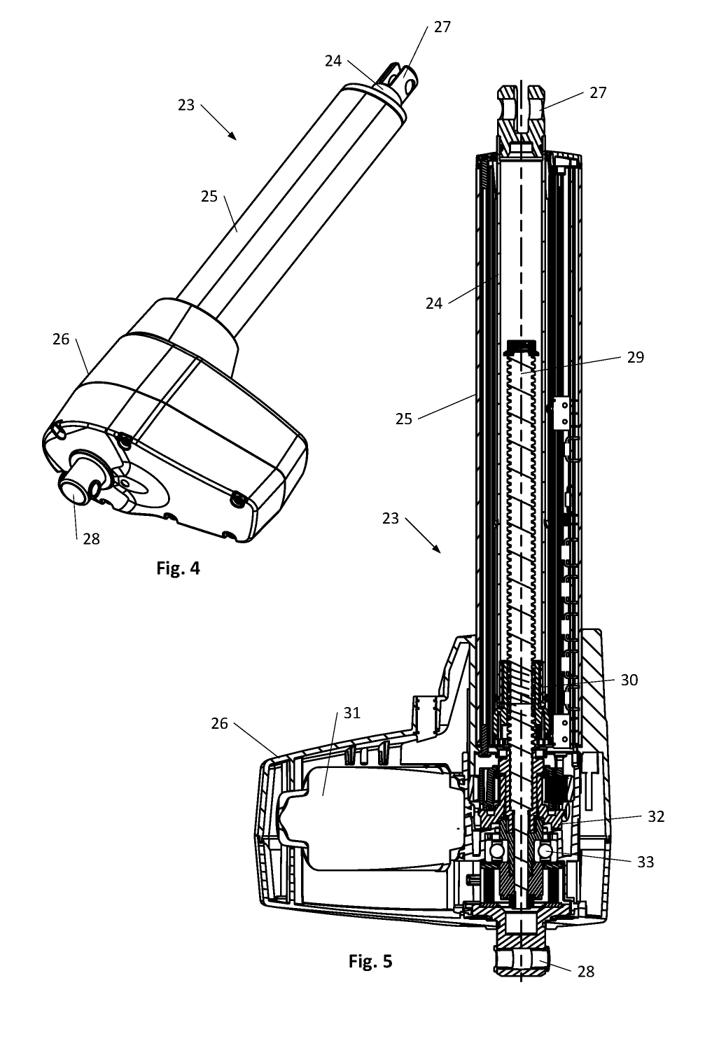

FIG. 4 shows a linear actuator,

FIG. 5 shows the linear actuator in FIG. 4, where the motor housing and the outer tube have been partially removed,

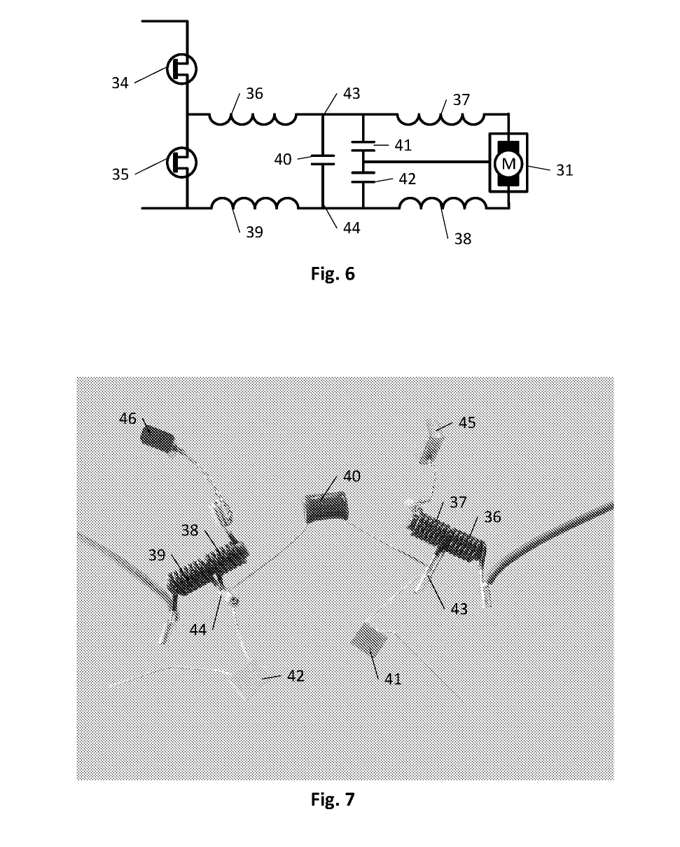

FIG. 6 shows a diagram of an arrangement for electrical noise dampening of a motor for an output stage of a controller,

FIG. 7 shows a picture of the components of the electrical noise dampening according to the diagram in FIG. 6,

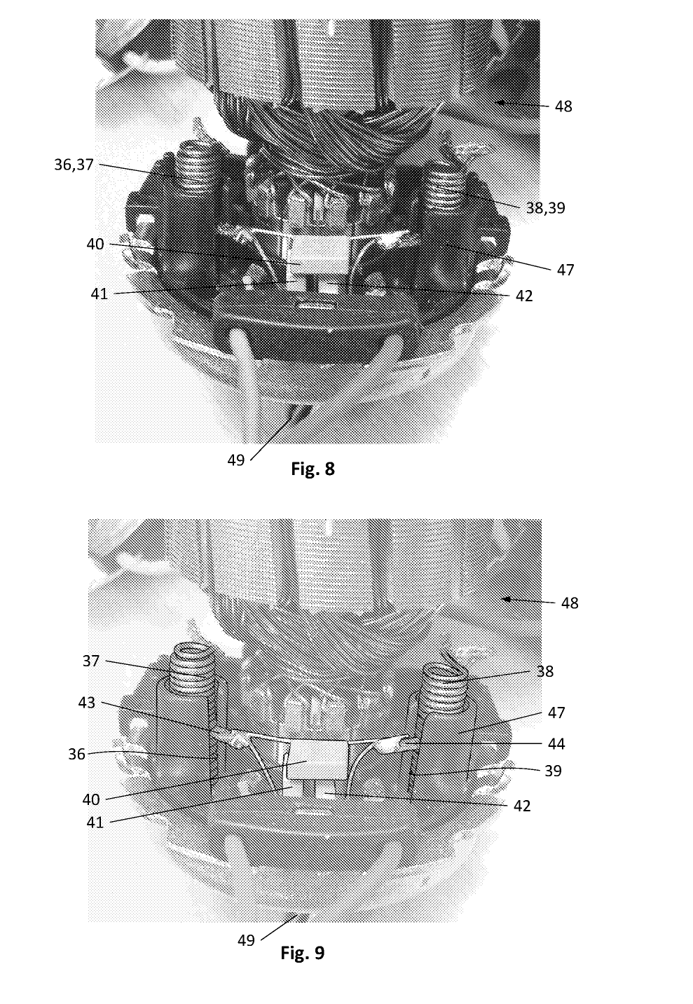

FIG. 8 shows a disassembled motor such that the components of the electrical noise dampening according to the diagram in FIG. 6 are visible, and

FIG. 9 shows the same picture as FIG. 8, in which the components of the electrical noise dampening have been sketched to highlight their position.

FIG. 1 shows a hospital bed 1 with a lower frame 3 equipped with drive wheels 2 and an upper frame 4. The upper frame 4 is fitted with an adjustable carrying surface 5 for a mattress (not shown). The carrying surface 5 comprises a back rest section 6, an articulated leg rest section 7 and a fixed middle section 8 between these. The back rest and leg rest section 6,7 can be adjusted by means of an actuator 9,10 each, such that the carrying surface 5 can assume different contours. The upper frame 4 is connected to the lower frame 2 with a link mechanism 11,12 at each end. The upper frame 4 can be raised and lowered by means of a pair of actuators 13,14 connected to the link mechanisms 11,12. All the actuators 9,10,13,14 are connected to a control box 15 containing a controller 19 (see FIG. 3). The control box 15 can be connected to mains and can e.g. be equipped with a power supply. The control box 15 can further comprise a rechargeable battery pack.

A junction box 16 is connected to the control box 15 for connecting one or more operating units, such as a hand control 17 and an operating panel 18 integrated into the headboard of the bed, as well as possible other peripheral equipment. The assembled system comprising the actuators 9,10,13,14, the control box 15 and operating units 17,18 is known as an actuator system. It is understood that the operating units 17,18 in an embodiment can also be directly connected to the control box 15. Thus, such an embodiment of the actuator system does not comprise a junction box.

FIG. 2 shows a schematic view of a hospital and care bed in a different embodiment than the bed in FIG. 1. Here, the lower frame 3 and the upper frame 4 is not connected by means of link mechanisms, but are instead connected via two linear actuators designed as lifting columns 21,22.

FIG. 3 shows a block diagram of the actuator system on the bed in FIG. 1.

FIG. 4 shows a linear actuator 23 of the type comprising a piston rod described in the preamble and is thus of the same type as the linear actuators 9,10,13,14. The piston rod is also known as an inner tube. The linear actuator 23 comprises an outer tube 25 and a motor housing 26. The linear actuator 23 further comprises a front mounting 27 at the outer end of the inner tube 24 and a rear mounting 28 at the motor housing 36.

FIG. 5 shows the linear actuator in FIG. 5, where the motor housing 26 and the outer tube 25 has been partially removed. The main features of the linear actuator 23 comprises a spindle unit consisting of a spindle 29 on which a spindle nut 30 is arranged. The spindle nut 30 can be secured against rotation. The inner tube 24 is secured to the spindle nut 30 and can thus be moved in and out of the outer tube 25 depending of the direction of rotation of the spindle 29. The spindle 29 is driven by a reversible electric motor 31 via a transmission.

Here, the transmission comprises a worm arranged in continuation of the drive shaft of the electric motor, as well as a worm wheel 32 secured to the spindle 29. A bearing 33 is further secured to the spindle 29. The bearing 33 can e.g. be a ball bearing or a roller bearing.

The linear actuator 23 shown in FIGS. 4 and 5 only illustrates the main components. The linear actuator 23 can thus also be equipped with a braking device, additional bearings, quick release mechanism etc.

FIG. 6 shows a diagram for a circuit for electrical noise dampening of an electric motor for an output stage of a controller. The output stage of the controller, illustrated by means of the FET-transistors 34, 35 is a switch-mode controller, adapted for pulse width modulation of the operating voltage. In other words, the transistors function as switches, which are either completely open or completely closed. Application of a switch-mode controller provides advantages with regard to energy efficiency and speed control. When the transistor is activated, while the transistor 35 is closed, a current runs through the inductance 36, further through the inductance 37 for operation of the electric motor 31 and further through the inductances 38 and 39. When the transistor 34 is interrupted while the transistor 35 is closed a current will still run due to the inductances. This current can be considered constant over a short period of time. Thus, an energy efficient speed control of the electric motor can be achieved by altering the opening and closing times of the transistors 34, 35. The electric motor will necessarily have to be electrically noise dampened, as the commutation, the electromagnetic coupling and the switch-mode controller produce electrical noise. The noise is dampened by means of a capacitor 40 inserted into the common middle point of the inductances 36,39 and the inductances 37,38. The inductances 36,39 are inserted in order to prevent an otherwise very high peak current, as the capacitor 40 is coupled in parallel to the transistors 34,35. A high peak current will make great demands on the ability of the transistors to handle large currents. Moreover, a high amount of power will be dissipated in the transistors 34, 35, as the resistivity thereof will result in a switch loss. Further, a capacitor 41, 42 is inserted, which efficiently dampens noise of the electric motor relative to the motor housing. The inductances 36, 39; 37, 38 are single coils, of which the coils 37, 38 are normally arranged in the housing of the electric motor and the coils 36, 39 are arranged in connection with the output stage of the controller. It is immediately apparent that the coils 36, 37 and 38, 39 have a common midpoint 43, 44. Thus, the two coils 36, 37 and 38, 39 according to the invention can be wound as one coil with a tap, on which the capacitors 40, 41, 42 are connected. This provides a simpler solution, where the cost price of the assembled component 36, 37 and 38, 39 is only slightly higher than the price of one single coil 36, 37, 38, 39.

The solution further provides an effective noise dampening of the electric motor and can be used in connection with both a DC controller and a switch-mode controller, for which reason the customer and the manufacturer will not have to choose between variations with different types of electrical noise dampening and design noise dampening means themselves.

FIG. 7 shows a picture of the components of the electrical noise dampening according to the diagram in

FIG. 6. The coils 36,37 and 38,39 are both wound as one interconnected coil with a tap 43,44 each. Thus, the tap 43 is located between the coil sections 36 and 37, while the tap 44 is located between the coil sections 38 and 39. The brushes 45,46 are connected to one end of the coils 36,37 and 38,39. The capacitor 40 is connected to the taps 43 and 44. One of the supply lines on each of the capacitors 41 and 42 are connected to the taps 43 and 44. The other supply line on each of the capacitors 41 and 42 are in FIG. 7 not shown as being connected to anything, but are as shown in FIG. 6 prepared for connection to the motor housing.

FIGS. 8 and 9 shows a picture of the motor which has been opened and with focus on the electrical noise dampening according to the diagram in FIG. 6, which here is arranged in connection with the brush holder 47 of the motor. It is thus noted that the motor housing is not shown. In FIG. 9 the coils 36,37 and 38,39 as well as the capacitors 40,41,42 are sketched in order to highlight their position. In the background the armature 48 and the motor shaft 49 can be seen. It is particularly apparent that the coils 36, 37 and 38, 39 have been wound as one interconnected coil equipped with a central tap in the shape of a common midpoint 43, 44, to which the capacitors 40, 41, 42 are connected. This is both practical and financially advantageous, as the coils can be constructed in one cycle.

1. An actuator system comprising:
at least one electrically driven linear actuator comprising an electric motor, a transmission, a spindle connected to the electric motor via the transmission, on said spindle a spindle nut is arranged,
and an electric controller with an operating unit,
a first circuit for a first electrical noise dampening of the electric motor comprising a first inductance and two capacitors,
a second circuit for a second electrical noise dampening of the electric motor, arranged between the circuit for the first electrical noise dampening of the electric motor and the electric controller, comprising a second inductance and a capacitor characterized in that the actuator system comprises a coil, of which the first inductance and the second inductance constitute a first section and a second section of the coil, respectively.

2. The actuator system according to claim 1, characterized in that the coil comprises a tap, said tap being a common middle point dividing the coil into the first section and the second section.

3. The actuator system according to claim 2, characterized in that the coil comprises one interconnected winding.

4. The actuator system according to claim 2, characterized in that the coil as a unit is equipped with one core.

5. The actuator system according to claim 2, characterized in that the coil individually on each of the two sections is equipped with one core.

6. The actuator system according to claim 3, characterized in that the core is made from a material containing ferrite.

7. The actuator system according to claim 2, characterized in that the coil and the additional components in the first and second circuit for electrical noise dampening of the electric motor are arranged in the housing of the electric motor or mounted on the terminals of the electric motor.

8. The actuator system according to claim 2, characterized in that the coil and the additional components in the first and second circuit for electrical noise dampening of the electric motor are arranged in the housing of the actuator.

9. The actuator system according to claim 2, characterized in that the coil and the additional components in the first and second circuit for electrical noise dampening of the electric motor are arranged in a separate housing.

10. The actuator system according to claim 2, characterized in that the coil and the additional components in the first and second circuit for electrical noise dampening of the electric motor are arranged in the controller.
